(19) United States
(12) Patent Application Publication
(10) Pub. No.: US 2016/0059763 A1
(43) Pub. Date: Mar. 3, 2016

(54) Retractable bed ramps with platform for a pickup truck

(71) Applicant: Michael J. Sindoni, JR., Delanson, NY (US)

(72) Inventor: Michael J. Sindoni, JR., Delanson, NY (US)

(21) Appl. No.: 14/834,548

(22) Filed: Aug. 25, 2015

Related U.S. Application Data
(60) Provisional application No. 62/043,799, filed on Aug. 29, 2014.

(51) Int. Cl. B60P 1/43

(52) U.S. Cl. CPC B60P 1/431; B60P 1/43

(57) ABSTRACT

A low-profile, heavy duty platform which with fit between the wheel wells of a pickup truck comprises retractable bed ramps with a platform for a pickup truck. Retractable ramps are provided within the platform, and each may be extended by pulling a handle located at the rear end of the ramp. When fully extended, each ramp hinges downward to contact the ground and provide an inclined surface for the loading and unloading of another, smaller vehicle. The platform is preferably provided in a pickup truck equipped with double doors which swing outward, instead of a tailgate. In another embodiment, the platform is provided in a pickup truck with a tailgate, and provides a strong, rigid extension at the hinged forward end of each ramp. The extension may be extended with the ramp by continuing to pull on the handle after the ramp is fully extended.

### CROSS-REFERENCE TO RELATED APPLICATIONS

This Application claims the benefit of U.S. Provisional Application No. 62/043799, filed Aug. 29, 2015, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to pickup truck equipment and accessories, and in particular to retractable bed ramps with a platform for a pickup truck. For both work and play, the pickup truck has become the most popular type of vehicle in the United States, outselling both sedans and sport utility vehicles. A variety of lighter, special-purpose vehicles, such as riding lawnmowers, motorcycles, golf carts, and all-terrain vehicles (ATVs), have generally been towed behind pickup trucks on flatbed trailers, but many owners would prefer to save fuel and space in their driveways by carrying these special purpose vehicles directly in the bed of the pickup truck. Particularly with the popularity of such super duty pickup trucks as the Ford F-350, even certain types of light construction equipment, such as a small end loader or excavator, could conceivably be carried in the bed. Unfortunately, the conventional tailgate configuration would be severely damaged, as well as the bed; and moving such vehicles into the bed is impossible without ramps. Certain types of ramps have been developed but these are generally unsatisfactory, and do nothing to protect the tailgate or the bed from damage. Retractable bed ramps with a platform, which are factory installed with either a conventional tailgate or a pair of double doors, would resolve these problems.

### SUMMARY OF THE INVENTION

Accordingly, the invention is directed to retractable bed ramps with a platform for a pickup truck. The invention is comprised of a low-profile, heavy duty platform which with fit between the wheel wells of a pickup truck. Retractable ramps are provided within the platform, and each may be extended by pulling a handle located at the rear end of the ramp. When fully extended, each ramp hinges downward to contact the ground and provide an inclined surface for the loading and unloading of another, smaller vehicle. The platform is preferably provided in a pickup truck equipped with double doors which swing outward, instead of a tailgate. In another embodiment, the platform is provided in a pickup truck with a tailgate, and provides a strong, rigid extension at the hinged forward end of each ramp. The extension may be extended with the ramp by continuing to pull on the handle after the ramp is fully extended.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate two embodiments of the invention and, together with the description, serve to explain the principles of the invention.

FIG. 1 is a top perspective view of the first exemplary embodiment with the ramps retracted, displaying the platform 10, the handles 12, the pickup truck 13, the bed 14, and the double doors 15.

FIG. 2 is a rear perspective view of the first exemplary embodiment with both ramps extended, displaying the platform 10, the ramps 11, the handles 12, the pickup truck 13, the bed 14, the double doors 15.

FIG. 3 is a rear perspective view of the first exemplary embodiment with one ramp extended, displaying the platform 10, the ramp 11, the handle 12, the pickup truck 13, the bed 14, and the double doors 15.

FIG. 4 is a top perspective view of the second exemplary embodiment with the ramps extended, displaying the platform 10, the handles 12, the pickup truck 13, the bed 14, and the tailgate 16.

FIG. 5 is a rear perspective view of the second exemplary embodiment with both ramps extended, displaying the platform 10, the ramps 11, the extensions 11A, the handles 12, the pickup truck 13, and the bed 14.

FIG. 6 is a rear perspective view of the second exemplary embodiment with one ramp extended, displaying the platform 10, the ramp 11, the handle 12, the pickup truck 13, and the bed 14.

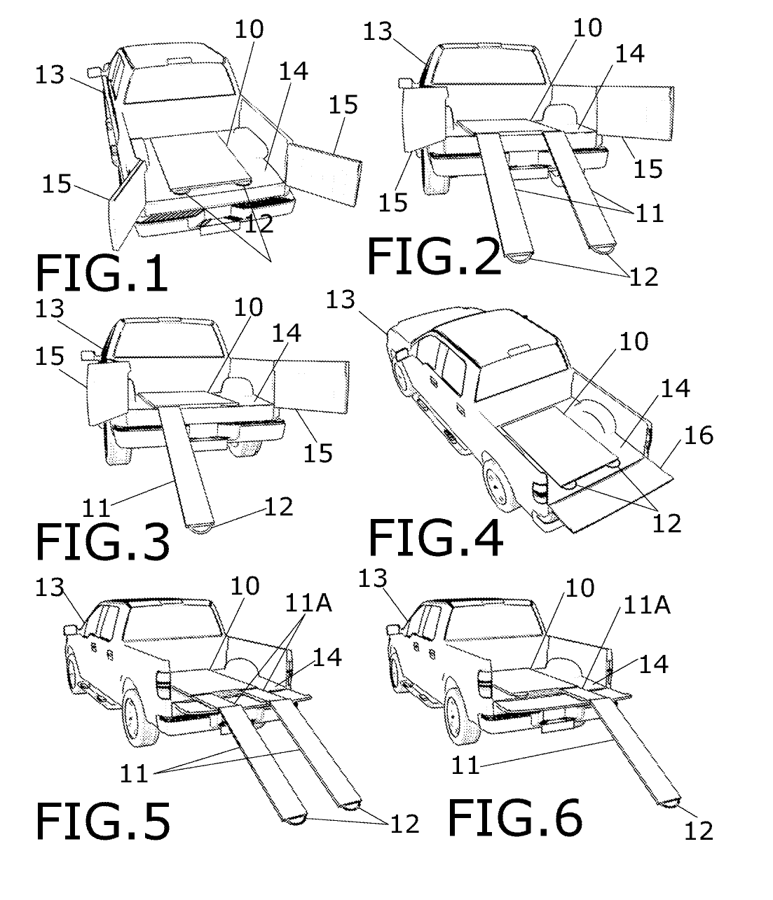

### DETAILED DESCRIPTION OF THE INVENTION

Referring now to the invention in more detail, the invention is directed to retractable bed ramps 11 with a platform 10 for a pickup truck 13.

The invention is intended to be installed as original equipment by the pickup truck manufacturer. Alternate embodiments, which may be installed as an after-market modification by the owner of the pickup truck 13, or by a repair or customizing shop, are contemplated.

The first exemplary embodiment is comprised of a low-profile, heavy duty platform 10 which with fit between the wheel wells of the bed 14 of a pickup truck 13. Retractable ramps 11 are provided within the platform 13, and each may be extended by pulling a handle 12 located at the rear end of the ramp 11. When fully extended, each ramp 11 hinges downward to contact the ground and provide an inclined surface for the loading and unloading of another, smaller vehicle, such as a golf cart, an all-terrain vehicle (ATV), a riding lawnmower, a motorcycle, or a small excavator or end loader. Each ramp 11 extends and retracts easily, preferably on roller bearings or large rollers.

In the first exemplary embodiment, the platform 10 is provided in a pickup truck 13 equipped with double doors 15 which swing outward, instead of a tailgate 16. Each ramp 11 may be extended individually, in the event that the user does not need to extend both ramps 11, such as the loading and unloading of a motorcycle. The platform 10 with ramps 11 may be hoisted out of the bed 14 of the pickup truck 13, and is temporarily secured with bolts or similar fasteners. Steel eyes or similar structures, for the attachment of hoisting chains or to secure a payload, are preferably provided at the corners and edges of the platform 10.

To use the first exemplary embodiment, the user opens the double doors 15 and pulls on one or both handles 12 until the ramps 11 are fully extended. When fully extended, the ramps 11 may be hinged downward to contact the ground. A light vehicle may then be loaded or unloaded, using the ramps 11.

The second exemplary embodiment is structurally and functionally similar to the first exemplary embodiment with the following modification. The platform 10 is provided in a pickup truck 13 with a conventional tailgate 16, and provides a strong, rigid extension 11A at the hinged forward end of each ramp 11. The extension 11A may be extended with the ramp 11 by continuing to pull on the handle 12 after the ramp 11 is fully extended.

To use the second exemplary embodiment, the user opens the tailgate 16 and pulls on one or both handles 12 until the ramps 11 are fully extended. The user then continues pulling on one or both handles 12 until the extensions 11A are also fully extended. When fully extended, the ramps 11 may be hinged downward to contact the ground. A light vehicle may then be loaded or unloaded, using the ramps 11.

The platform 10, the ramps 11, the extensions 11A, and the handles 12 are preferably manufactured from a rigid, durable material with substantial structural strength, such as steel or aluminum alloy. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A ramp system for a pickup truck having a bed and a tailgate, the ramp system comprising:
(a) a longitudinal bed channel recessed into a floor of the bed, the bed channel defining a bottom surface having a longitudinal bed track;
(b) a longitudinal tailgate channel recessed into an inner-panel of the tailgate, the tailgate channel aligned with the bed channel and defining a bottom surface having a longitudinal tailgate track, the inner panel facing the floor of the bed when the tailgate is in a closed position; and
(c) a ramp member having a track member, the ramp member configured to be stowed in the bed channel in a stowed position and slidable in the bed and tailgate channels from the stowed position to a fully deployed position during which the track member moves along the respective bed and longitudinal tailgate tracks without having to raise the track member out of the respective bed and longitudinal tailgate tracks;

2. The ramp system of claim 1, wherein, in the fully deployed position, the ramp member extends from the longitudinal tailgate track, at an outer end of the tailgate when the tailgate is in an open position, the outer end being opposed to an inner end of the tailgate that is adjacent to the floor, at an incline to a ground surface.

3. The ramp system of claim 2, wherein the track member comprises a head member pivotably coupled thereto, and wherein the head member comprises an end member that is slidably movable in and along the bed track and the longitudinal tailgate track.

4. The ramp system of claim 1, wherein the bed and longitudinal tailgate channels are substantially horizontally aligned when the tailgate is in the open position.

5. The ramp system of claim 1, wherein a top surface of the ramp members is flush with a surface of the floor in the stowed position and during movement through the bed and longitudinal tailgate channel.

6. The ramp system of claim 5, wherein the top surface of the ramp member is a same material as the surface of the bed.

7. The ramp system of claim 1, wherein the bed and longitudinal tailgate tracks are recessed relative to a bottom surface of the bed and tailgate channels, respectively, and wherein the track members extend below the bottom-surface of the bed and tailgate channels to a slidably engage the bed and longitudinal tailgate tracks.

8. The ramp system of claim 1, wherein the track member is at a cab-side end of the ramp member when the ramp member is in the stowed position, the cab-side end opposed to a tailgate side end of the ramp member.

9. The ramp system of claim 8, wherein the track member is lockable at a position along the bed or longitudinal tailgate track or in the fully deployed position.

10. The ramp system of claim 9, wherein the track member is lockable at the cab-side end of the ramp member in the stowed position.

11. The ramp system of claim 1, wherein the longitudinal bed channel comprises a pair of longitudinal bed channels laterally spaced apart, wherein the longitudinal tailgate channel comprises a pair of longitudinal tailgate channels spaced laterally apart, and wherein the ramp member comprises a pair of ramp members.

12. The ramp system of claim 11, wherein the pairs of longitudinal bed and tailgate channels and tracks are substantially longitudinally aligned.

13. A vehicle comprising:
(a) a cargo area having a floor and a closure member moveable between an open position and a closed position, the closure member having n inner panel facing the cargo floor when in the closed position;
(b) a ramp system including: a pair of longitudinal floor channels recessed into the floor of the cargo area and laterally spaced apart from each other, the floor channels each defining a bottom surface having a longitudinal floor track; a pair of longitudinal closure member channels aligned with the bed channels and each defining a bottom surface having a longitudinal closure member track; and a pair of ramp members each having a track member, the pair of ramp members configured to be stowed in the floor channels in a stowed position and slidable in the floor and closure member channels from the stowed position to a fully deployed position during which the track members move along the respective bed and longitudinal closure member tracks and into the fully deployed position without having to raise the track members out of the respective bed and longitudinal closure member tracks.

14. The vehicle of claim 13, wherein the vehicle is a pickup truck, wherein the cargo area is a bed, and wherein the closure member is a tailgate.

15. The vehicle of claim 13, wherein each track member comprises a head member pivotably coupled thereto, and wherein the head member comprises and end member that is slidably movable in and along its respective floor track and its respective longitudinal closure member track.

16. The vehicle of claim 13, wherein the floor and longitudinal closure member channels are substantially horizontally aligned when the closure member is in the open position.

17. The vehicle of claim 13, wherein a top surface of each ramp member is flush with a surface of the floor in the stowed position and during movement through the floor and closure member channels.

18. The vehicle of claim 13, wherein the closure member separates in the middle and opens laterally towards the sides of the closure member.

19. A ramp system for a pickup truck having a bed and a tailgate, the ramp system comprising:
(a) a longitudinal bed channel, the longitudinal bed channel defining a bottom surface having a longitudinal bed track, and the longitudinal bed channel defining a top surface;
(b) a ramp member having a track member, the ramp member having an extension, the extension being configured to extend the ramp member past the tailgate, the ramp member and extension configured to be stowed in the bed channel in a stowed position and slidable in the bed channel from the stowed position to a fully deployed position during which the ramp member and extension moves along the respective bed tracks without having to raise the track member out of the respective bed tracks;

20. The ramp system of claim 19, wherein, in the fully deployed position, the ramp member extends from the extension, at an outer end of the tailgate when the tailgate is in an open position, the outer end being opposed to an inner end of the tailgate that is adjacent to the floor, at an incline to a ground surface.

21. The ramp system of claim 20, wherein the track member comprises a head member pivotably coupled thereto, and wherein the head member comprises an end member that is slidably movable in and along the bed track.

22. The ramp system of claim 19, wherein the ramp members are concealed within a platform in the stowed position and during movement through the bed channel; the platform being secured to the bed.

23. The ramp system of claim 22, wherein the top surface of the ramp member is a same material as the surface of the bed.

24. The ramp system of claim 19, wherein the bed tracks are concealed within a platform containing the bed channels and wherein the track members extend to slidably engage the bed tracks.

25. The ramp system of claim 19, wherein the track member is at a cab-side end of the ramp member when the ramp member is in the stowed position, the cab-side end opposed to a tailgate side end of the ramp member.

26. The ramp system of claim 25, wherein the track member is lockable at a position along the bed track or in the fully deployed position.

27. The ramp system of claim 26, wherein the track member is lockable at the cab-side end of the ramp member in the stowed position.

28. The ramp system of claim 19, wherein the longitudinal bed channel comprises a pair of longitudinal bed channels laterally spaced apart and wherein the ramp member comprises a pair of ramp members.

29. The ramp system of claim 28, wherein the pairs of longitudinal bed and tracks are substantially longitudinally aligned.

30. A vehicle comprising:
(a) a cargo area having a floor and a closure member moveable between an open position and a closed position, the closure member having an inner panel facing the cargo floor when in the closed position;
(b) a ramp system including: a pair of longitudinal floor channels concealed within a platform and laterally spaced apart from each other, the floor channels each defining a bottom surface having a longitudinal floor track; and a pair of ramp members each having a track member and an extension, the pair of ramp members configured to be stowed in the floor channels in a stowed position and slidable in the floor and closure member channels from the stowed position to a fully deployed position during which the track members move along the respective bed and longitudinal closure member tracks and into the fully deployed position without having to raise the track members out of the respective bed and longitudinal closure member tracks.

31. The vehicle of claim 30, wherein the vehicle is a pickup truck, wherein the cargo area is a bed, and wherein the closure member is a tailgate.

32. The vehicle of claim 30, wherein each track member comprises a head member pivotably coupled thereto, and wherein the head member comprises and end member that is slidably movable in and along its respective floor track and its respective longitudinal closure member track.

33. The vehicle of claim 30, wherein the closure member separates in the middle and opens laterally towards the sides of the closure member.
